(19) United States
(12) Patent Application Publication
(10) Pub. No.: US 2009/0201558 A1
(43) Pub. Date: Aug. 13, 2009

(54) IMAGE FORMING APPARATUS AND CONTROL METHOD

(75) Inventor: Akihiko Kida, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/366,036

(22) Filed: Feb. 5, 2009

Related U.S. Application Data
(60) Provisional application No. 61/027,246, filed on Feb. 8, 2008.

(51) Int. Cl. H04N 1/00

(52) U.S. Cl. 358/404

(57) ABSTRACT

An image forming apparatus includes a memory that has a first storage area for storing a control program and a second storage area for storing image data and operates in a normal mode and a self-refresh mode. The image forming apparatus stores the control program in the first storage area to set the first storage area in the self-refresh mode, when the power saving mode, stores image data which is stored in the second storage area, in the storage medium to set the second storage area in a dormant state, when the storage medium is connected to a main body in the power saving mode, and sets at least a bank of the second storage area in which the image data is stored, in the self-refresh mode and sets the remaining bank in the dormant state, when the storage medium is not connected to the main body in the power saving mode.

### CROSS-REFERENCE TO RELATED APPLICATION

This application is based upon and claims the priority of U.S. Provisional Application No. 61/027,246, filed on Feb. 8, 2008, the entire contents of which are incorporated herein by reference.

### TECHNICAL FIELD

The present invention relates to image forming apparatuses such as an MFP (Multi-Function Peripheral) as a digital complex machine, a copying machine, and a printer, and, more particularly to an image forming apparatus with reduced power consumption and a control method therefor.

### BACKGROUND

In general, in an image forming apparatus such as an MFP, a copying machine, or a printer, power consumption is reduced from the viewpoint of environmental protection. The image forming apparatus has, for reduction in power consumption, a normal power mode and a power saving mode with reduced power consumption.

For example, in the normal power mode (a normal mode) the image forming apparatus supplies electric power to respective units such as an operation panel, a scanner unit, and a printer unit to perform copy processing and print processing. In the power saving mode, the image forming apparatus is set in a sleep mode for turning off display of the operation panel and turning off the scanner unit and the printer unit to reduce power consumption.

In the sleep mode, in order to reduce power consumption, the image forming apparatus stops a high-power consuming CPU or reduces the speed of an operation clock of the CPU. Further, in order to reduce power consumption of a DRAM, the image forming apparatus transitions only a predetermined memory area to self-refresh.

JP-A-2004-273029 discloses a storage device that self-refreshes only a predetermined memory area.

When a power supply is isolated in order to reduce power consumption, adequate startup time is necessary when the power supply is turned on again. Therefore, the isolation of the power supply is not practical.

### SUMMARY

It is an object of the present invention to provide an image forming apparatus and a control method therefor that can reduce power consumption.

According to an aspect of the present invention, there is provided an image forming apparatus having a power saving mode comprising:

an image forming unit including a printer unit;

a memory that has a first storage area for storing a control program and a second storage area including plural banks for storing image data and operates in a normal mode and a self-refresh mode;

a nonvolatile storage medium connectable to a main body of the image forming apparatus; and

a control unit that controls an operation mode of the memory, stores the control program in the first storage area to set the first storage area in the self-refresh mode, when the power saving mode, stores image data which is stored in the second storage area in the storage medium to set the second storage area in a dormant state, when the nonvolatile storage medium is connected to the main body in the power saving mode, and sets at least a bank of the second storage area in which the image data is stored in the self-refresh mode and sets the remaining bank in the dormant state, when the nonvolatile storage medium is not connected to the main body.

### DESCRIPTION OF THE DRAWINGS

FIG. 1 is a diagram of an image forming apparatus according to an embodiment;

FIG. 2 is a block diagram of a circuit configuration of the image forming apparatus according to the embodiment;

FIG. 3 is a flowchart for explaining operations of the image forming apparatus according to the embodiment; and

FIGS. 4A to 4E are diagrams for explaining memory control for the image forming apparatus according to the embodiment.

### DETAILED DESCRIPTION

Throughout this description, the embodiments and examples shown should be considered as exemplars, rather than limitations on the apparatus and methods of the present invention.

An image forming apparatus according to an embodiment is explained in detail below with reference to the accompanying drawings. In the drawings, the same components are denoted by the same reference numerals and signs.

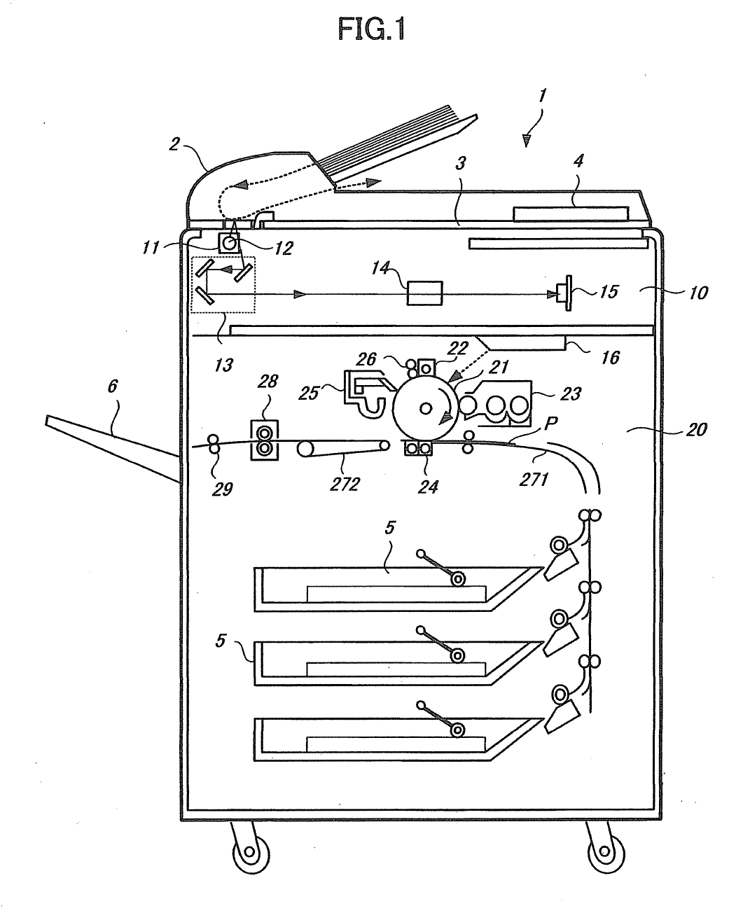

FIG. 1 is a diagram of the image forming apparatus according to the embodiment. In the following explanation, an MFP (Multi-Function Peripheral) as a complex machine is explained as an example of the image forming apparatus.

In FIG. 1, an image forming apparatus (an MFP) 1 includes, in an upper part thereof, an automatic document feeder (ADF) 2, a transparent document table 3, and an operation panel 4. The MFP 1 also includes a scanner unit 10 and a printer unit 20. The scanner unit 10 scans an image of an original document. The printer unit 20 forms an image on a sheet.

The scanner unit 10 includes a carriage 11, an exposure lamp 12, a reflection mirror 13, a lens 14, and a CCD (Charge Coupled Device) 15. In order to scan an original document fed by the ADF 2 or an original document placed on the document table 3, the scanner unit 10 irradiates light from the exposure lamp 12 provided in the carriage 11 on the original document from below the document table 3 and leads reflected light from the original document into the CCD 15 via the reflection mirror 13 and the lens 14.

Image information captured by the CCD 15 is outputted as an analog signal. The analog signal is converted into a digital signal and subjected to image processing to generate image data. The image data is supplied to a laser unit 16. The laser unit 16 generates a laser beam according to the image data.

The printer unit 20 includes a photoconductive member 21. A charging device 22, a developing device 23, a transfer device 24, a cleaner 25, a charge removing lamp 26 are provided around the photoconductive member 21 along a rotating direction of the photoconductive member 21. The laser beam from the laser unit 16 is irradiated on the photoconductive member 21. An electrostatic latent image corresponding to the image information of the original document is formed and held on an outer circumferential surface of the photoconductive member 21.

When image formation is started, the charging device 22 discharges in a predetermined discharge position and uniformly charges, in an axial direction, the outer circumferential surface of the rotating photoconductive member 21 with predetermined charges. Subsequently, a laser beam is irradiated on the photoconductive member 21 from the laser unit 16. An electrostatic latent image is formed and held on the outer circumferential surface of the photoconductive member 21.

A developer (e.g., a toner) is supplied to the outer circumferential surface of the photoconductive member 21 by the developing device 23. The electrostatic latent image is converted into a toner image and developed. The toner image formed on the outer circumferential surface of the photoconductive member 21 is electrostatically transferred onto a sheet P by the transfer device 24. The sheet P is conveyed from one of plural paper feeding devices 5 (explained later) through a conveying path 271. The toner remaining on the photoconductive member 21 without being transferred is removed by the cleaner 25 located downstream in the rotating direction of the photoconductive member 21. Thereafter, residual charges on the outer circumferential surface of the photoconductive member 21 are removed by the charge removing lamp 26.

On the other hand, in order to feed a sheet to the printer unit 20, the plural paper feeding devices 5 are provided below the printer unit 20. Sheets fed from the paper feeding devices 5 are conveyed to the transfer device 24 by a conveyor belt 271.

The sheet P having the toner image transferred thereon by the printer unit 20 is conveyed to a fixing device 28 via a conveyor belt 272. In the fixing device 28, a heating roller and a pressing roller are provided to be opposed to each other. The toner image transferred onto the sheet P is fixed on the sheet P by passing the sheet P between the heating roller and the pressing roller. The sheet P having the toner image fixed thereon, for which the image formation is completed, is discharged to a tray 6 by a paper discharging roller 29.

A configuration of the printer unit 20 is not limited to the example shown in FIG. 1. Other systems such as a system employing ink-jet recording can also be used. Further, the MFP 1 can process print data inputted from a PC (Personal Computer) or the like, output the print data to the printer unit 20, and print the print data.

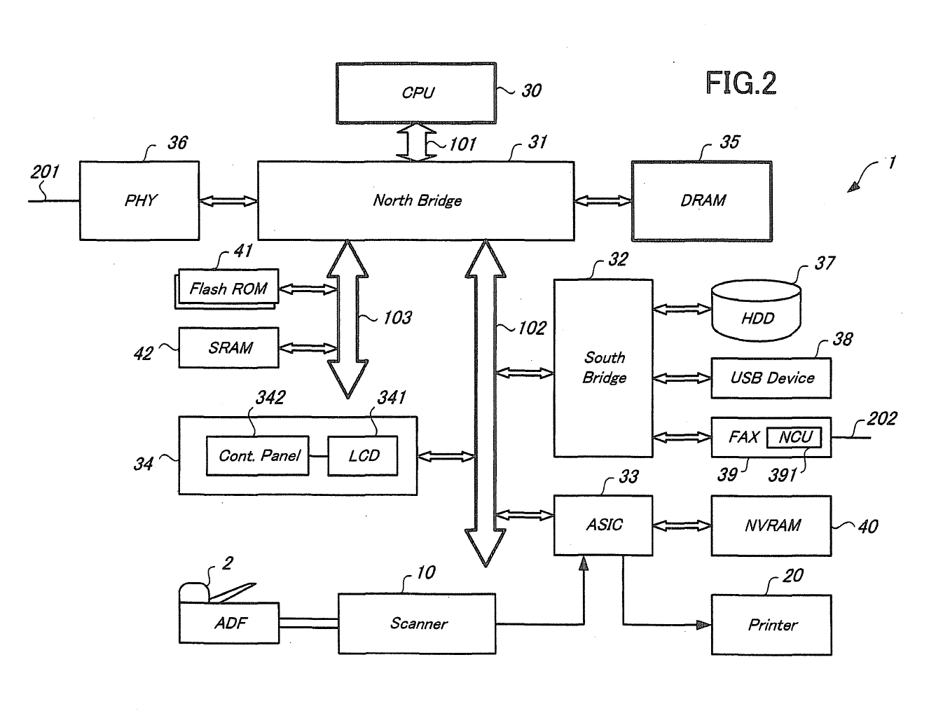

FIG. 2 is a block diagram of a circuit configuration of the image forming apparatus (the MFP) 1. As shown in FIG. 2, the MFP 1 includes a CPU 30, a north bridge 31, a south bridge 32, an ASIC (Application Specific IC) 33, and an operation unit 34. The CPU 30 and the north bridge 31 are connected via a bus line 101. Bus lines 102 and 103 are connected to the north bridge 31. The north bridge 31 and the south bridge 32 control operations of the MFP 1 under the control by the CPU 30.

A DRAM 35 and a PHY (Physical Layer Device) 36 are connected to the north bridge 31. An HDD 37 as a recording medium and a USB device 38 are connected to the south bridge 32. A facsimile unit 39 is also connected to the south bridge 32. An NVRAM 40, the scanner unit 10, and the printer unit 20 are connected to the ASIC 33. An ADF 2 is connected to the scanner unit 10.

The south bridge 32, the ASIC 33, and the operation unit 34 are connected to the north bridge 31 via the bus line 102. A flash ROM 41 (hereinafter referred to as ROM 41) and an SRAM 42 are connected to the bus line 103. The ROM 41 and the SRAM 42 are connected to the north bridge 31 via the bus line 103.

In FIG. 2, the CPU 30 controls operations of the entire MFP 1. The north bridge 31 arbitrates and controls input and output of data among the devices connected to the bus lines 101, 102, and 103. The north bridge 31 configures a control unit that controls operations of a main memory (the DRAM 35).

The south bridge 32 arbitrates and controls input and output of data among the HDD 37, the USB device 38, and the facsimile unit 39. The ASIC 33 subjects image data scanned by the scanner unit 10 to compression processing and stores the image data in the NVRAM 40. Further, the ASIC 33 reads out the stored image data, subjects the image data to expansion processing and image processing (gradation reproduction, etc.), and outputs the image data to the printer unit 20.

The scanner unit 10 operates in conjunction with the ADF 2 and sequentially scans original documents in sheet units fed from the ADF 2. The scanner unit 10 scans an original document placed on the document table 3 and generates scan data as image data. The printer unit 20 generates image data including RAW data of a bitmap format immediately before printing. The scanner unit 10 and the printer unit 20 form an image on a sheet in response to the operation of the operation unit 34. The scanner unit 10 and the printer unit 20 configure an image forming unit.

The operation unit 34 includes a liquid crystal display unit (an LCD 341), a control panel 342 integral with the LCD 341, a CPU (not shown), and various operation keys. The control panel 342 is a touch panel integral with the LCD 341. On the control panel 342, a user can perform various kinds of display and various kinds of setting. The user operates the operation panel 342 to input instructions for the number of prints and a sheet size, a print instruction, and the like.

The DRAM 35 functions as a main memory. The DRAM 35 can store programs and data for execution of various kinds of processing by the CPU 30 and can operate in a normal operation mode and a self-refresh mode.

The DRAM 35 includes plural banks (in this example, four banks). Among the plural banks, one bank is allocated as an area for storing an OS (Operating System) and a control program and the other banks are allocated as areas for storing, for example, image data scanned by the scanner 10, image data generated by a PC explained later, and image data received by the facsimile unit 39.

The DRAM 35 includes a refresh circuit and a register. The DRAM 35 can transition a predetermined area to the refresh mode in bank units. When the MFP 1 is in a sleep mode, the DRAM 35 sets only a predetermined bank in the self-refresh mode and sets the other banks dormant to reduce power consumption. Refresh control is explained in detail later.

The PHY 36 functions as a network interface. The PHY 36 converts packet data transmitted through a network 201 into digital data and captures the digital data into the MFP 1. The PHY 36 converts the digital data from the MFP 1 into an electric signal and outputs the electric signal to the network 201. The PHY 36 performs communication with a PC (Personal Computer) or the like set in a location apart from the MFP 1. The PC (not shown) can transmit image data for printing to the MFP 1 via the network 201.

The HDD (Hard Disc Drive) 37 can be connected to the MFP 1. It is possible to store various image data generated by the MFP 1 (image data scanned by the scanner unit 10 and image data generated by the PC) in the HDD 37 and read out the image data from the HDD 37 by connecting the HDD 37 to the MFP 1. The image data stored in the HDD 37 can be read out and printed in the printer unit 20. When the MFP 1 is in the sleep mode, the HDD 37 functions as a nonvolatile memory that can store image data even if the supply of power is turned off.

The USB device 38 is a storage medium such as a CF (Compact Flash). Like the HDD 37, the USB device 38 is possible to store various image data generated by the MFP 1 in the USB device 38 and read out the image data from the USB device 38 by connecting the USB device 38 to the MFP 1. The storage of the image data in and readout of the image data from the HDD 37 and the USB device 38 are performed under the control by the south bridge 32. The CPU 30 determines via the south bridge 32 whether the HDD 37 and the USB device 38 are connected to the MFP 1.

The facsimile unit 39 transmits and receives data via a telephone line 202. The facsimile unit 39 includes an NCU (Network Control Unit) 391. The facsimile unit 39 is connected to the telephone line 202, transmits image data for facsimile generated by the MFP 1 through the telephone line 202, and receives image data from the outside.

The NVRAM 40 is a nonvolatile memory backed-up by a not-shown battery or the like. The NVRAM 40 stores various setting data of the MFP 1. The ROM 41 stores a control program including an OS (Operating System) for causing the MFP 1 to operate. The SRAM 42 is a storing unit for a work area for temporarily storing a calculation result and the like during execution of a program.

The control program including the OS is stored in the ROM 41. However, the control program may be expanded on the DRAM 35 to use the DRAM 35 as a work area. Therefore, the area (the bank) for storing the control program is provided in the DRAM 35.

When print processing and the like are not performed, the MFP 1 is transited to the power saving mode (e.g., the sleep mode). In the sleep mode, an operation frequency of the high-power consuming CPU 30 is set low and command execution and clock supply by the CPU 30 are stopped. The CPU 30 transitioned to the sleep mode returns to a normal state when an interrupt signal set in advance is inputted from the outside. For example, in the sleep mode, when the operation unit 34 is operated by the user or a signal is received by the PHY 36, the interrupt signal is inputted to the CPU 30. The CPU 30 returns to the normal state.

In the sleep mode, the DRAM 35 causes only a predetermined bank to operate in the self-refresh mode. The self-refresh mode is a mode for automatically performing refresh processing for a memory and storing data even if a clock and a command are not inputted from the outside. In the self-refresh mode, it is possible to reduce power consumption of the memory compared with that at normal time. The transition to the self-refresh mode is performed by holding a clock enable (CKE) signal of the predetermined bank of the DRAM 35 at a LOW level.

However, further reduction in power consumption for electronic apparatuses are demanded according to increasing demands for measures against global warming and a reduction in energy. In the present invention, power consumption is reduced by controlling a refresh operation of the DRAM 35 in the sleep mode.

A method of controlling the DRAM 35 is explained below.

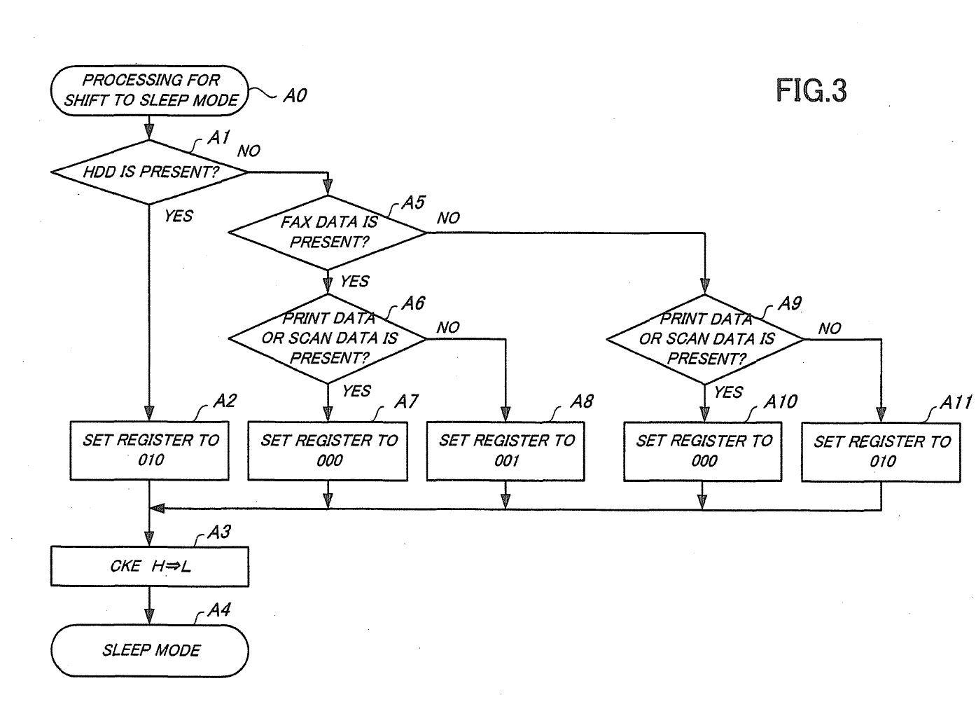

FIG. 3 is a flowchart of a refresh operation of the DRAM 35 performed when the MFP 1 shifts to the sleep mode.

In FIG. 3, Act A0 indicates processing for shift to the sleep mode. In Act A1, the control unit determines whether the HDD 37 is connected to the MFP 1. As a condition for transition to the sleep mode, fixed time elapses after completion of operation or after discharge of a last sheet and there is no waiting job.

When the control unit determines in Act A1 that the HDD 37 is connected to the MFP 1, in Act A2, a value “0, 1, 0” is set in the register in the DRAM 35.

The control unit can refresh the DRAM 35 in bank units and designate, according to a set value of the register, which bank should be set in the self-refresh mode. When a value of the register is, for example, “0, 1, 0”, the control unit can set one bank in the self-refresh mode. When the value of the register is “0, 0, 0”, the control unit can set all the banks (three banks) in the self-refresh mode. When the value of the register is “0, 0, 1”, the control unit can set two banks in the self-refresh mode.

In Act A2, since the value of the register is “0, 1, 0”, the control unit sets one bank in the self-refresh mode. In Act A3, the control unit changes clock enable (CKE) of the one bank from H (High level) to L (Low level) In the DRAM 35, only a first bank is in the self-refresh mode and the other banks are in the dormant state.

The control program including the OS stored in the ROM 41 is stored in the first bank of the DRAM 35. The DRAM 35 is used as a work area. Therefore, even in the sleep mode, it is possible to immediately execute, for example, processing for interrupting the CPU 30 and allow the MFP 1 quickly return to the normal mode.

When image data such as facsimile data, print data, or scan data is stored in the DRAM 35 before the MFP 1 enters the sleep mode, the facsimile data, the print data, or the scan data is transferred to the HDD 37 and temporarily stored in the HDD 37. Therefore, it is possible to store information in the HDD 37 even when the banks other than the first bank are in the dormant state. Moreover, since the banks other than the first bank are in the dormant state, it is possible to reduce power consumption of the DRAM 35. The image data temporarily stored in the HDD 37 is read out from the HDD 37 and stored in the DRAM 35 when the MFP 1 returns to the normal mode from the sleep mode.

As an example of shifting to the sleep mode while keeping image data or the like stored in the DRAM 35 rather than immediately printing the image data or the like, there is private printing. The private printing is printing for, for example, imparting confidentiality to print data transmitted from a PC. The print data is once stored in the DRAM 35 with a password given thereto. The data stored in the DRAM 35 cannot be printed unless the user operates the MFP 1 to input the password. Therefore, it could frequency occur that the MFP 1 shifts to the sleep mode while keeping the print data or the like stored in the DRAM 35 without immediately printing the print data or the like.

On the other hand, when the control unit determines in Act A1 that the HDD 37 is not connected to the MFP 1, in Act 5 and subsequent acts, the control unit checks presence or absence of facsimile data, print data, or scan data in the DRAM 35. In Act A5, the control unit determines presence or absence of facsimile data. When the facsimile data is stored in the DRAM 35, the control unit shifts to Act A6.

In Act A6, the control unit determines whether print data or scan data is stored in the DRAM 35. When the control unit determines in Act A6 that the print data or the scan data is stored in the DRAM 35, in Act A7, the control unit sets the value of the register to “0, 0, 0”.

When the value of the register is “0, 0, 0”, the control unit sets all the banks (the four banks) of the DRAM 35 in the self-refresh mode and, in Act A3, changes the clock enable (CKE) of all the banks of the DRAM 35 from “H” to “L”. The OS and the control program are stored in the first bank of the DRAM 35, the facsimile data is stored in a second bank, and the print data and the scan data are stored in third and fourth banks. The respective banks are set in the self-refresh mode.

When the control unit determines in Act A6 that the print data and the scan data are not stored, in Act A8, the control unit sets the value of the register to “0, 0, 1”. When the value of the register is “0, 0, 1”, the control unit sets two banks of the DRAM 35 in the self-refresh mode and, in Act A3, change the clock enable (CKE) of the two banks of the DRAM 35 from “H” to “L”. Therefore, the OS and the control program are stored in the first bank and the facsimile data is stored in the second bank of the DRAM 35. The first bank and the second bank are set in the self-refresh mode. A storage area for the print data or the scan data of the DRAM 35 is set in the dormant state. Therefore, it is possible to reduce power consumption.

When the control unit determines in Act A5 that the facsimile data is not present, the control unit shifts to Act A9. In Act A9, the control unit determines whether the print data or the scan data is stored in the DRAM 35. When the control unit determines in Act A9 that the print data or the scan data is stored, in Act A10, the control unit sets the value of the register to “0, 0, 0”.

When the value of the register is “0, 0, 0”, the control unit sets all the banks (the four banks) of the DRAM 35 in the self-refresh mode. In Act A3, the control unit changes the clock enable (CKE) of all the banks of the DRAM 35 from “H” to “L”. The OS and the control program are stored in the first bank of the DRAM 35. The print data and the scan data are stored in the third and fourth banks. The first, third, and fourth banks are set in the self-refresh mode. Nothing is stored in the second bank.

When the control unit determines in Act A9 that the print data or the scan data is not stored, in Act A11, the control unit sets the value of the register to “0, 1, 0”. When the value of the register is “0, 1, 0”, the control unit sets one bank of the DRAM 35 in the self-refresh mode. In Act A3, the control unit changes the clock enable (CKE) of the first bank of the DRAM 35 from “H” to “L”. Therefore, the control program including the OS is stored in the first bank of the DRAM 35. The first bank is in the self-refresh mode. The second, third, and fourth banks can be set in the dormant state. Therefore, it is possible to reduce power consumption.

In the example explained the above, the control unit designates one bank, two banks, or all the banks and shifts the bank(s) to the self-refresh mode according to the value of the register. However, when a bank to be set in the self-refresh mode can be finely designated, the control unit can designate three banks.

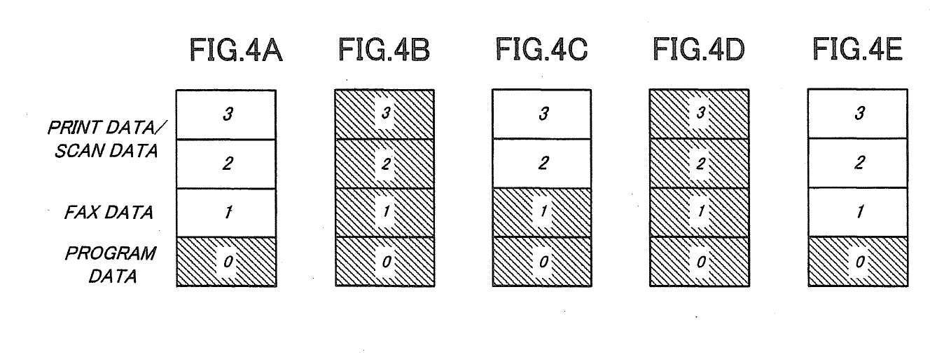

FIGS. 4A to 4E are diagrams for explaining an overview of a self-refresh operation of the DRAM 35. In FIGS. 4A to 4E, the DRAM 35 is sectioned into four banks (banks 0 to 3). The bank 0 indicates an area for storing the OS or the control program and the bank 1 indicates an area for storing the facsimile data. The bank 2 and the bank 3 respectively indicate areas for storing the print data and the scan data.

In FIGS. 4A to 4E, hatched areas are in the self-refresh mode and represent a mode corresponding to the register values in Acts A2, A7, A8, A10, and A11 shown in FIG. 3.

In FIG. 4A, a self-refresh area that is set when the HDD 37 is connected to the MFP 1 is shown. When the HDD 37 is connected to the MFP 1, only one bank (the bank 0) is set as the self-refresh area in order to secure a minimum area equivalent to the work area of the DRAM 35.

In FIG. 4B, a self-refresh area that is set when the HDD 37 is not connected to the MFP 1, the facsimile data is present, and the print data or the scan data is present is shown. All the banks (the four banks) are set as the self-refresh area.

In FIG. 4C, a self-refresh area that is set when the HDD 37 is not connected to the MFP 1, the facsimile data is present, and the print data and the scan data are not present is shown. Only two banks are set as the self-refresh area.

In FIG. 4D, a self-refresh area that is set when the HDD 37 is not connected to the MFP 1, the facsimile data is not present, and the print data or the scan data is present is shown. All the banks (the four banks) are set as the self-refresh area.

In FIG. 4E, a self-refresh area that is set when the HDD 37 is not connected to the MFP 1, the facsimile data is not present, and the print data and the scan data are not present either is shown. As in FIG. 4A, only one bank is set as the self-refresh area.

When all the banks are set in the self-refresh mode, a consumed current is, for example, about 400 μA. When only two banks are set in the self-refresh mode, the consumed current can be reduced about 25% to 300 μA. When only one bank is set in the self-refresh mode, the consumed current can be reduced about 40% to 250 μA.

According to the embodiment explained above, it is possible to transition the MFP 1 to the sleep mode and reduce power consumption in order to reduce power consumption of the MFP 1 during standby. Since the operations of the MFP 1 are not completely stopped, it is possible to quickly start the MFP 1 when the MFP 1 returns to the normal mode.

In the sleep mode, the predetermined area of the DRAM 35 is set in the self-refresh mode and the remaining areas are set in the dormant state according to whether the storage medium such as the HDD 37 or the USB device 38 is connected to the MFP 1 or according to presence or absence of various image data. Therefore, it is possible to reduce power consumption.

In the example explained above, when the HDD 37 is connected to the MFP 1, the facsimile data, the print data, and the scan data stored in the DRAM 35 are temporarily stored in the HDD 37. However, the facsimile data, the print data, and the scan data may be stored in a storage device such as the USB device 38 (Compact Flash) instead of the HDD 37. When the data are stored in the USB device 38, in Act A1 shown in FIG. 3, the CPU 30 determines whether the USB device 38 is connected to the MFP 1. When both the HDD 37 and the USB device 38 are connected to the MFP 1, it is advisable to preferentially store the data of the DRAM 35 in any one of the storage media.

The present invention is not limited by the above explanation. Various modifications are possible without departing from the scope of claims.

Although exemplary embodiments of the present invention are shown and described, it will be apparent to those having ordinary skill in the art that a number of changes, modifications, or alterations as described herein may be made, none of which depart from the spirit. All such changes, modifications, and alterations should therefore be seen as within the scope.

What is claimed is:

1. An image forming apparatus having a power saving mode comprising:
an image forming unit including a printer unit;
a memory that has a first storage area for storing a control program and a second storage area including plural banks for storing image data and operates in a normal mode and a self-refresh mode;
a nonvolatile storage medium connectable to a main body of the image forming apparatus; and
a control unit that controls an operation mode of the memory, stores the control program in the first storage area to set the first storage area in the self-refresh mode, when the power saving mode, stores image data which is stored in the second storage area in the storage medium to set the second storage area in a dormant state, when the nonvolatile storage medium is connected to the main body in the power saving mode, and sets at least a bank of the second storage area in which the image data is stored in the self-refresh mode and sets the remaining bank in the dormant state, when the nonvolatile storage medium is not connected to the main body.

2. The apparatus of claim 1, wherein
the first storage area of the memory includes one bank,
the second storage area includes plural banks, and
the control unit sets the storage areas in the self-refresh mode in units of the respective banks.

3. The apparatus of claim 2, further comprising a scanner unit, wherein
the memory has a first bank for storing the control program, a second bank for storing scan data generated by the scanner unit, and a third bank for storing print data generated by an external PC.

4. The apparatus of claim 3, further comprising a facsimile unit that processes a facsimile signal, wherein
the second storage area of the memory has plural banks for respectively storing the scan data generated by the scanner unit, the print data generated by the PC, and facsimile data generated by the facsimile unit, and
the control unit sets the banks of the second storage area for storing the facsimile data, the scan data, and the print data in the self-refresh mode, when the nonvolatile storage medium is not connected to the main body in the power saving mode.

5. The apparatus of claim 1, wherein the control unit determines whether private print data is stored in the memory and sets the banks of the second storage area in the self-refresh mode, when the power saving mode.

6. The apparatus of claim 1, wherein the memory includes a register, and designates according to an output value of the register, which of the banks of the first and second storage areas should be set in the self-refresh mode.

7. The apparatus of claim 1, wherein the control unit stores the image data which is stored in the nonvolatile storage medium in the power saving mode, in the second storage area of the memory from the nonvolatile storage medium when the memory returns to the normal mode.

8. The apparatus of claim 1, wherein the memory is a DRAM.

9. The apparatus of claim 1, wherein the nonvolatile storage medium is an HDD.

10. The apparatus of claim 1, wherein the nonvolatile storage medium is a USB device.

11. A control method for an image forming apparatus having a power saving mode,
the image forming apparatus providing an image forming unit including a printer unit, a memory that has a first storage area and a second storage area and operates in a normal mode and a self-refresh mode, and a nonvolatile storage medium connectable to a main body of the image forming apparatus,
the control method comprising:
storing a control program in the first storage area to set the first storage area in the self-refresh mode, when the power saving mode;
storing image data which is stored in the second storage area in the storage medium to set the second storage area in a dormant state, when the nonvolatile storage medium is connected to the main body in the power saving mode; and
setting at least a bank of the second storage area in which the image data is stored in the self-refresh mode and setting the remaining bank in the dormant state, when the nonvolatile storage medium is not connected to the main body in the power saving mode.

12. The method of claim 11, wherein
the first storage area of the memory includes one bank,
the second storage area includes plural banks, and
the storage areas are set in the self-refresh mode in units of the respective banks.

13. The method of claim 11, wherein
the image forming apparatus further includes a scanner unit, and
the memory has a first bank for storing the control program, a second bank for storing scan data generated by the scanner unit, and a third bank for storing print data generated by an external PC.

14. The method of claim 13, wherein
the image forming apparatus further includes a facsimile unit that processes a facsimile signal,
the second storage area of the memory has plural banks for respectively storing the scan data generated by the scanner unit, the print data generated by the PC, and facsimile data generated by the facsimile unit, and
the method further includes setting the banks of the second storage area for storing the facsimile data, the scan data, and the print data in the self-refresh mode, when the nonvolatile storage medium is not connected to the main body in the power saving mode.

15. The method of claim 11, further comprising determining whether private print data is stored in the memory and setting the banks of the second storage area in the self-refresh mode, when the power saving mode.

16. The method of claim 11, wherein
the memory includes a register, and
the method further includes designating according to an output value of the register, which of the banks of the first and second storage areas should be set in the self-refresh mode.

17. The method of claim 11, further comprising storing the image data which is stored in the nonvolatile storage medium in the power saving mode, in the second storage area of the memory from the nonvolatile storage medium when the memory returns to the normal mode.

18. The method of claim 11, wherein the memory is a DRAM.

19. The method of claim 11, wherein the nonvolatile storage medium is an HDD.

20. The method of claim 11, wherein the nonvolatile storage medium is a USB device.
